(19) United States
(12) Patent Application Publication
(10) Pub. No.: US 2015/0321893 A1
(43) Pub. Date: Nov. 12, 2015

(54) Method and Apparatus for Preserving and Dispensing a Food Product, In Particular a Yogurt

(71) Applicants: COMPAGNIE GERVAIS DANONE, Paris (FR); ATENA SRL, Falciano (SM)

(72) Inventors: Federico CORBELLI, Domagnano (SM); Benoit LIENART, La Celle Saint Cloud (FR)

(21) Appl. No.: 14/649,482

(22) PCT Filed: Dec. 4, 2013
(86) PCT No.: PCT/EP2013/075457

§ 371 Date: Jun. 3, 2015

(30) Foreign Application Priority Data
Dec. 4, 2012 (FR) 12 61579

(51) Int. Cl. B67D 1/00; B67D 1/10; B67D 1/08; B67D 1/12

(52) U.S. Cl. CPC B67D 1/0007; B67D 1/1256; B67D 1/108; B67D 1/0858; B67D 1/0888

(57) ABSTRACT

The apparatus (1) according to the invention for preserving and dispensing a food product such as a yogurt has a tank (4) outside which the product can be extracted by actuating an extraction device (20) and set in motion by a peristaltic pump (5). The apparatus makes it possible to cool the reservoir (4) in a cooling area, engage the pump (5) with a flexible hose (14) of a dispensing line (15) connected to the reservoir and, in response to an order transmitted via an interface (33), extract the food product by rotating a rotor (22) of the pump in a first direction, such that a dose corresponding to the order may be recovered at an outlet (16) of the dispensing line. The circulation of the food product in the dispensing line (15) is modified at the end of the dispensing operation so as to move the food product remaining in the line away from the outlet (16).

### TECHNICAL FIELD OF THE INVENTION

The present invention relates to an apparatus and method for preserving and dispensing, on demand, a liquid or pasty (i.e., with the intermediate consistency between liquid and solid) food product, typically a cold dairy product such as a yogurt composition, for example.

### BACKGROUND OF THE INVENTION

The use of a malleable reservoir for storing a liquid food product from which a flexible distribution tube exits is already known from document EP 0,053,813. A pump cooperates with the distribution tube. An extracting device is provided to cause the product to flow through said distribution tube. An extraction lever or button makes it possible to withdraw an individual dose of the product on demand.

A dispensing device comprising this type of malleable reservoir is practical in that the reservoir is simple to connect and change. However, the device described in EP 0,053,813 does not make it possible to ensure preservation of the product, such that it is not suitable for dispensing cold dairy products. Furthermore, dairy products have a higher viscosity than liquid beverages. Due to the higher viscosity of a dairy product (a mixed fermented milk composition, for example yogurt of the Activia® type, typically being able to reach 1100 mPa·s at a typical storage temperature of approximately 5° C.), circulation in a loop of the dispensing tube may be less effective. As a result, the user may not be sure of obtaining the desired dose of the product. This limits the scope of application of this type of device.

Furthermore, with this type of device, cleaning is complicated and it is considered necessary in practice to throw away all of the lines associated with the malleable reservoir. In other words, when the reservoir has been emptied or when a usage limit has been reached (for example, 5 days from connection of the tube to the opening), it is necessary to replace the reservoir along with its recirculation tube, as well as the flexible tube. One drawback of the aforementioned device is that the consumable part (to be thrown away after use), which has several nozzles, is relatively complex and therefore fairly expensive. This limits the commercial interest of this type of device.

Dispensing devices such as shown in US 2003/008974 A1 require a plurality of thin pouches each accommodated in a narrowly profiled cassette. A dispensing tube attached to the pouch is engaged by a peristaltic pump for distribution of the food product. The cost of such cassettes and proper accommodation thereof reduce the interest of such devices. Additionally, the dispensing tube essentially extends downwardly from the cassette and is located outside the refrigerated area. This is not in line with preservation requirements, especially for sensitive food products.

There is therefore a need for systems for preserving and dispensing dairy products combining several of the following advantages:
use of a reservoir that is more suitable for storage and preservation requirements;
simplification of the consumable parts;
reduction in the number of steps necessary to change the reservoir (the system then being more attractive for the person responsible for managing it);
ease of extracting a dose of product for the consumer.

### BRIEF DESCRIPTION OF THE INVENTION

The present invention aims to improve this situation by making the system more effective and attractive and making it well suited for preserving and dispensing cold dairy products.

To that end, the apparatus for preserving and dispensing, on demand, a liquid or pasty food product includes:
a storage compartment;
a food product reservoir, which is typically in the form of a flexible pouch;
a dispensing line connected to the reservoir and having an outlet, the dispensing line channeling the food product and comprising a flexible hose;
an extraction device for extracting the food product channeled into the dispensing line, configured to circulate the food product toward the outlet in response to a command to dispense a dose of food product, said extraction device comprising a peristaltic pump from which one end of the dispensing line extends including the outlet, the dispensing line being connected to the reservoir at another end that is opposite the outlet, the pump having a rotor rotating around an axis of rotation at least in a first direction corresponding to a descending circulation of the food product toward the outlet, the extraction device being configured to modify the circulation of the food product in the dispensing line at the end of dispensing of a dose of food product;
a cooling device suitable for refrigerating the food product contained in the reservoir when the reservoir is in the storage compartment.

According to one particularity, the rotor comprises several rollers and the pump further includes a rotational driving element configured to rotate the rotor selectively in the first direction and in a second direction corresponding to an ascending circulation of food product, such that the lower end can be at least partially emptied, at the end of the dispensing of a dose. The rotation in the second direction (corresponding to an ascending circulation of the food product) is controlled so that the product can rise in the dispensing line without reaching an upper level downstream of the reservoir, in order to avoid any air rising up inside the reservoir.

The apparatus thus makes it possible to control the circulation of a food product having a high viscosity (such as a yogurt) until the end of dispensing and to improve the preservation of that product by modifying, at the end of the dispensing, circulation so as to move the quantity of product remaining near the outlet differently. It will be understood that modifying the circulation, preferably inverting the circulation direction, makes it possible to extract product in the end of the line that is adjacent to the compartment (typically not refrigerated) where the dose of food product is collected.

The inversion of the circulation direction is advantageous (and preferred rather than, for example, slowing the circulation before stopping) inasmuch as it effectively empties the end of the dispensing line, which in practice is furthest from the cooling area of the apparatus. Using a secondary device to modify the circulation, for example in the form of a vibrating system coupled to the pump and/or commanded when the pump reaches the end of a dispensing cycle, may also make it possible to limit the quantity of product remaining at the outlet. However, in that case, controlling of the dosing is more difficult and/or depends greatly on the viscosity of the food product actually used. The solution with inversion of the circulation direction makes it possible to eliminate this type of secondary device and provides excellent dosing precision. The product can then rise in the dispensing line, for example beyond a lower level that may correspond to the lower end of a curve of the flexible hose that is engaged with the rotor of the pump, without reaching an upper level downstream of the reservoir. As an example, this upper level may correspond to an upper end of the curve of the flexible hose engaged with the rotor.

In various embodiments of the apparatus according to the invention, it is optionally possible furthermore to use any of the following provisions:
the apparatus comprises a control unit to control the rotational driving element according to cycles each comprising a phase for rotating the rotor by several revolutions in the first direction and a predetermined rotation phase not greater than one or two revolutions in the second direction (thus, it is ensured that a same minimal movement withdrawing food product is done such that that product is not stored in a non-refrigerated area corresponding to the outlet, knowing that that minimal movement makes it possible to cause the product to rise into the refrigerated area);
the extraction device comprises a user interface connected to the control unit and comprising a display screen suitable for indicating at least one piece of information that may represent a filling state of the reservoir, a refrigeration state in the storage compartment, a usage duration of a reservoir and dispensing line assembly and/or passing a usage duration threshold of that assembly;
the pump comprises a stator portion arranged on the periphery of the rotor and forming at least one reaction surface engaged with the flexible hose in a pumping configuration in which said hose is locally crushed between at least one of the rollers and the reaction surface (such arrangement with a reaction surface is particularly suitable to efficiently displace the product upwardly);
the pump comprises an insertion channel to receive the flexible hose, the stator portion being movable between a position for accessing the insertion channel in which the stator portion is separated from the axis of rotation and a closed position of the insertion channel in which the stator portion is closer to that axis;
the reservoir and the pump are arranged in a same enclosure including the storage compartment and refrigerated by the cooling device (thus, the food product stored in the dispensing line before the next dispensing operation is also cooled; such configuration is particularly suitable to limit the rise of product in the dispensing line and avoid any air rising up inside the reservoir);
the pump has a casing containing the rotor and situated near a frontal access opening of the enclosure, the reservoir and the dispensing line defining a consumable assembly that can be removed with the casing through that frontal access opening (this configuration with easy access to the consumable part and the removable pump head simplifies the replacement operation);
the pump includes a drive shaft on which the rotor is mounted removably and can rotate in a fastening configuration in which the rotor is secured in rotation to the driveshaft, a folding door to close the storage compartment being configured (in a closed position of the door) to engage with the pump, so as to lock the fastening configuration of the rotor;
the outlet is situated in or near a collection compartment on the side of the lower end of the apparatus, the storage compartment extending on the side of an upper end of the apparatus to store the reservoir completely above the outlet (this arrangement optimizes the refrigeration and the energy necessary to ensure that the food product is kept cold);
the dispensing line extends continuously descending between the end opposite the outlet and the end including the outlet (with this arrangement, gravity does not oppose the circulation, which is advantageous in the case of a viscous product such as a yogurt);
the reservoir is a malleable packaging such as a flexible pouch, the shape and inner volume of which change with the help of the pump to facilitate the extraction of the food product outside the reservoir (this particularly facilitates emptying of a reservoir with a large capacity, for example at least 2 kg or 2 liters, in particular when the residual quantity of food product is low);
the reservoir is removable and forms part of a consumable (as the food product contained therein is perishable, such reservoir can be easily removed, in particular if usage expiration date has been exceeded).

Another aim of the invention is to propose an arrangement for circulating a food product, which can easily be loaded in a device for preserving and dispensing a cold food product such as a yogurt.

To that end, an arrangement is provided for circulating a liquid or pasty food product, capable of cooperating in an apparatus according to the invention, the arrangement comprising a food product reservoir, preferably in the form of a flexible pouch, a dispensing line that comprises a flexible hose and an outlet, and a peristaltic pump from which one end of the dispensing line extends including the outlet, the dispensing line being connected to the reservoir at another end opposite the outlet, the pump having:
a rotor including several rollers;
a rotational driving element configured to rotate the rotor around an axis of rotation in a first direction and in a second direction opposite the first direction, owing to which the circulation of the food product in the dispensing line can be modified.

The invention also provides a method for preserving and dispensing a liquid or pasty food product contained in a flexible pouch like reservoir outside which the food product can be extracted by actuating an extraction device and set in motion by peristaltic pump. This method comprises the following steps:
cooling the reservoir in a cooling area;
engaging the pump with a flexible hose of a dispensing line connected to the reservoir;
in response to a command to extract food product, extracting the food product from the reservoir by rotating the rotor of the pump in a first direction, such that a dose corresponding to the command may be recovered at an outlet of the dispensing line; and
when the dose is then removed from the dispensing line, moving the food product remaining in the dispensing line away from the outlet by rotating the rotor of the pump in a second direction, whereby said remaining food product is brought closer to the cooling area.

It should be mentioned that in the present application, a viscous or pasty food product refers to a product having a high viscosity, typically greater than 50 mPa·s, preferably greater than 300 mPa·s, and preferably lower than 2,000 mPa·s, preferably lower than 1,500 mPa·s. The viscosity may in particular be comprised between 600 mPa·s and 1,500 mPa·s. In the present application, unless otherwise stated, the indicated viscosities are viscosities measured at 10° C., with a shearing of 64 s⁻¹, after a time of 10 s at that shearing, using a rheometer with two coaxial cylinders, for example using a Mettler® RM 180 or 200 rheometer.

The food product is preferably a cold food product, for example fermented milk, for example yogurt. It is preferably a mixed fermented milk, for example a mixed yogurt.

### BRIEF DESCRIPTION OF THE DRAWINGS

Other features and advantages of the invention will appear during the following description of several embodiments, provided as non-limiting examples, in light of the attached drawings, in which:

FIG. 1 is a diagrammatic view showing the elements of a dispensing circuit of an apparatus according to one preferred embodiment of the invention;

FIGS. 2A and 2B respectively illustrate the closed configuration and the open configuration of the casing of a pump that can be used in the apparatus according to the invention;

FIGS. 3A and 3B are front views showing an apparatus with the door open, respectively before and after installation of the pump;

FIG. 4A shows a dispensing line closed by a stopper;

FIG. 4B shows the assembly formed by the reservoir and the dispensing line before use in an apparatus according to the invention;

FIG. 5 is a front view of an appliance for preserving and dispensing food products such as yogurt, in the operating state;

FIG. 6 is a perspective view showing the rear of an apparatus according to the invention;

FIG. 7 is a diagram illustrating steps that may be carried out upon removing the assembly formed by the reservoir and the dispensing line;

FIG. 8 illustrates an example of the connection of the shaft of a pump according to one embodiment according to the invention;

FIGS. 9A and 9B are respectively side and top diagrammatic views of a holder loaded with the reservoir, according to one embodiment of the invention.

### DETAILED DESCRIPTION OF THE INVENTION

In the different figures, identical references indicate identical or similar elements.

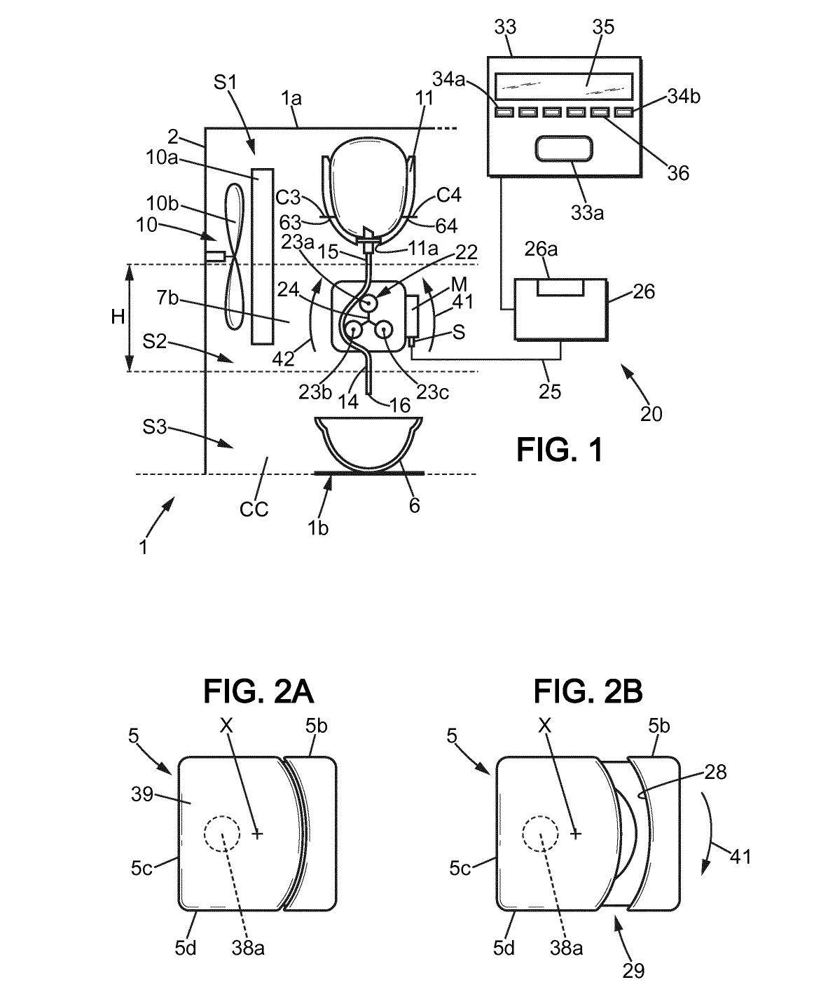

In reference to FIG. 1, the apparatus 1 has a chassis 2 that can be divided, at least for the purposes of the description, into several sections, respectively an upper section 51 in which a storage compartment 3 is provided for a food product reservoir 4, an intermediate section S2 in which a pump 5 can be mounted, and a lower section S3 having a collection compartment CC where the food product can be collected, for example using a suitable container such as a bowl or cup 6. The upper 51 and intermediate S2 sections contain an enclosure 7, thermally isolated to delimit a cooling area.

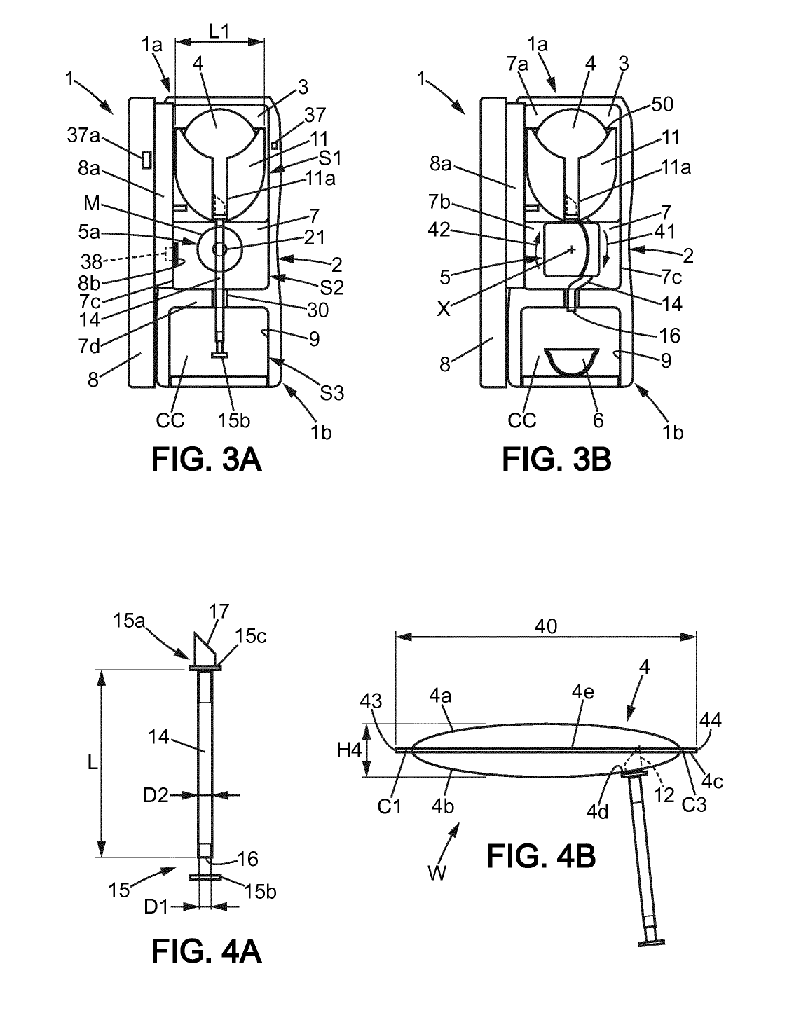

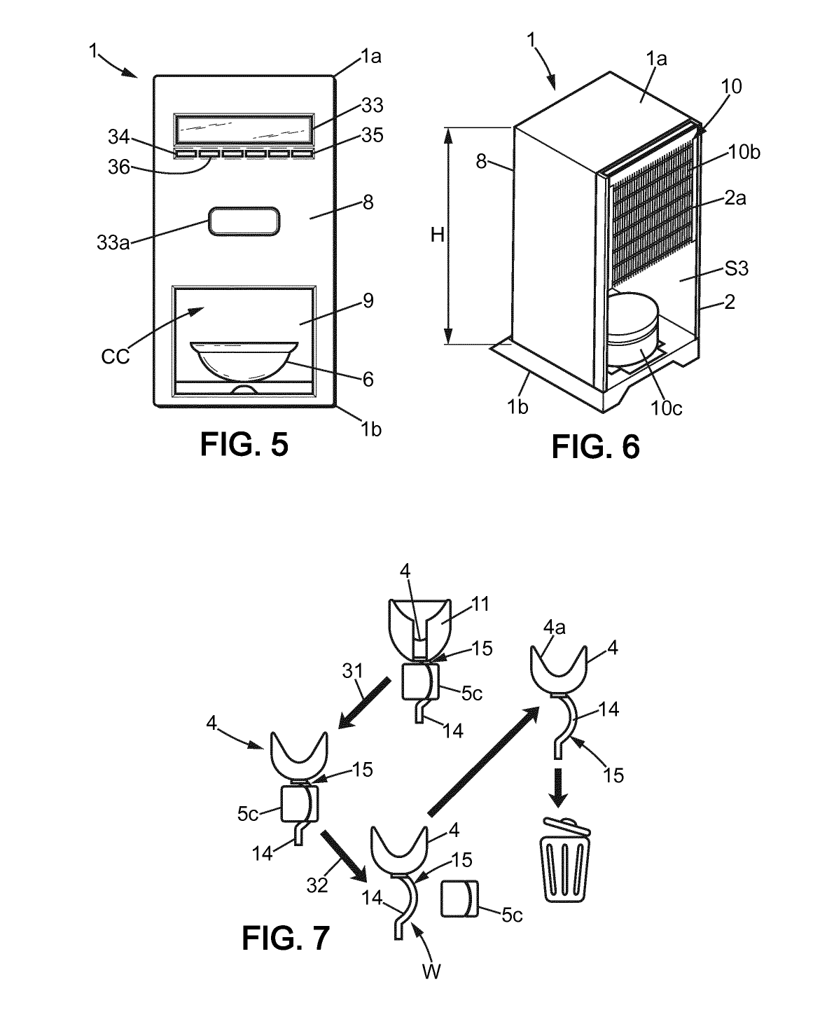

As shown in particular in FIG. 3B, the storage member 3 corresponds to or extends in a subpart 7a of the enclosure 7 that here is situated on the side of the upper end 1a of the apparatus 1 and superimposed on another subpart 7b of the enclosure 7 where the pump 5 is housed. The subpart 7b is preferably shallower than the subpart 7a. Housing the pump 5 under the storage compartment 3 makes it possible to limit the dimensions of the storage compartment 3, while the loading and unloading operations of the reservoir 4 may be facilitated as will be described later.

As shown in FIGS. 3A and 3B, the side walls of the chassis 2 and a folding door 8 arranged in the front of the chassis 2 delimit the enclosure 7, which emerges to the outside through an opening 7c allowing frontal access. When the apparatus 1 is used, this opening 7c is covered by the door 8, which comprises at least one isolating panel 8a. This opening 7c here provides frontal access for being situated on the same side as the access to the collection compartment CC. Under the enclosure 7, an opening 9 is also provided, preferably on the same side as the opening 7c for access to the enclosure 7, but not limited thereto. This opening 9, which is close to the lower end 1b of the apparatus 1, is not covered by the door 8 or then only partially, such that the collection compartment CC remains freely accessible after closing of the door 8.

A cooling interface of a cooling device 10, for example in the form of an evaporator exchanger 10a of a refrigerating facility, is arranged in the enclosure 7, preferably in a peripheral area of the storage compartment 3. A fan 10b of the cooling device 10 can be provided in the enclosure 7 so as to homogenize the temperature, in particular in the storage compartment 3. In reference to FIGS. 1 and 6, the cooling device 10 may be of a type known in itself and configured using a thermostat so that the temperature (which must remain above 0° C.) inside the storage compartment is comprised between 1 and 7° C., and preferably between 2 and 4° C. A refrigerating installation for example provided with a condenser 10b, a compressor 10c, an expander and the evaporator exchanger 10a is preferred, in particular when the ambient temperature may exceed 35° C. In order to minimize the outer volume of the apparatus 1 and in particular to reduce the height H, the chassis 2, which here is parallelepiped, may integrate the compressor 10c into its inner volume at the lower section S3, as illustrated in FIG. 6. In this way, the height of the upper section S1 may be reduced and the storage compartment 3 may extend as far as the rear wall 2a of the chassis 2 to have a depth substantially corresponding to the largest dimension or length 40 of the reservoir 4, visible in FIG. 4B.

In order to preserve the food product, facilitate dispensing by pumping, and simplify the replacement operations for the apparatus 1 with food product, the reservoir 4 here assumes the form of a malleable packaging such as a flexible pouch. The shape and inner volume of the flexible pouch change under the effect of the action of the pump 5, such that the extraction of the food product outside the reservoir 4 is made easier.

In one preferred embodiment and as shown in FIG. 4B in particular, the reservoir 4 may be made by assembling two sheets 4a, 4b of flexible material (for example, a plastic or multi-layer material), each having an oblong shape with dimensions that here are identical. The sheets 4a, 4b are welded to each other by a peripheral weld seam 4c. A quick connector 12 having an inner part and optionally an outer part is provided in one of the two sheets 4b. This quick connector 12 defines a single opening 4d of the reservoir 4. The single opening 4d is placed near a small side of the reservoir 4. This positioning may make it possible to facilitate emptying of the reservoir 4 when the latter is kept on a holder 11 with a slope or other means for raising the rear end 43 of the reservoir 4 opposite the single opening 4d. The quick connector 12 is for example made from rigid plastic. The oblong shape of the sheets 4a, 4b is preferred here because it makes it possible to obtain an overall shape that is very different from the cylindrical shape that is not advantageous for the effectiveness of the extraction in the reservoir 4 (in particular when the residual volume of food product is small). The welding in a median plane of the reservoir 4 further makes it possible to minimize the effects of folding, which create dead spaces.

More generally, it will be understood that the reservoir 4 may have any configuration suitable for forming a flexible pouch. Preferably, the outer walls of the reservoir 4 are in flexible plastic material and are continuously curved in a convex manner when the pouch has just been introduced in the cooling area (so as to increase the amount of content in the reservoir 4, without increasing the height). The plastic material used makes it possible to reduce the outer volume of that pouch when the food product is consumed and is suitable for contact with food. Of course, the reservoir 4 is airtight and it is preferable to use a single connecting member such as the quick connector 12 indicated above or another comparable sealing connector. In a horizontal position of the reservoir 4 as illustrated in FIG. 4B, the reservoir 4 has a height H4 that may correspond to its smallest dimension, that dimension being measured transversely with respect to the peripheral weld seam 4c.

In reference to FIGS. 1, 3A and 3B, the reservoir 4 here is mounted on a holder 11 that has an opening or a slit 11a. This holder 11 is placed in the storage compartment 3 and may be fastened removably. Preferably, the holder 11 slides horizontally in that storage compartment 3. The slit 11a extends vertically up to a bottom point of the holder 11, on the side of the opening 6. Owing to this slit 11a, the opening 4d may be oriented downward while being placed in a position adjacent to the intermediate section S2. Thus, the dispensing line 15 may have previously been connected to the reservoir 4 at the opening 4d, then be positioned through the slit 11a at the time of installation of the reservoir 4 in the storage compartment 3, while extending descending between its upper end for connecting to the reservoir 4 and its lower end at which an outlet 16 is provided. The sizing of the storage compartment 3 and the arrangement of the holder 11 for example allow the reservoir 4 to occupy approximately 90% of the inner volume of the storage compartment 3. In one alternative embodiment, walls of the storage compartment 3, for example provided with shoulders and optionally with a slit for guiding the dispensing line 15, may make it possible to directly support the reservoir 4 (which makes it possible to avoid the use of a removable holder).

In reference to FIGS. 4A and 4B, one can see that the dispensing line 15 may comprise only:
a flexible hose 14, which preferably has a length L comprised between 12 and 50 cm, and preferably comprised between 18 and 35 cm; and
a connecting member 15a, preferably a male member allowing a safe and quick connection by engagement with the quick connector 12 of the reservoir 4, after piercing the sheet 4b at the opening 4d.

The protective nozzle 15b shown in FIGS. 3A, 4A and 4B is optional and may be removed and thrown away before the first dispensing operation of the food product. Hereafter, the dispensing line 15 encompasses only the flexible hose 14 and the associated connecting member 15a, fastened by insertion into the flexible hose 14 at the upper end thereof. The length L of the flexible hose 14 is greater than the height H2 of the subpart 7b where the pump 5 is housed without exceeding twice that height H2. The insertion of the connecting member 15a into the opening 4d of the sheet 4b may be done while keeping the reservoir 4 with the sheet 4a in contact against a flat holder and pushing the tip 17 into the reservoir 4. The tip 17 is short enough with respect to the head of the reservoir 4 and the weld seam 4c prevents any risk of piercing the opposite sheet 4a. It will be understood that this configuration of the reservoir 4 is therefore practical and effective for an operator needing to install the assembly formed by the reservoir 4 and the dispensing line. Furthermore, the quick connector 12 of the reservoir may have means for rotational blocking (for example, by using a polygonal shape) and retention of the connection member 15a when the flange 15c is in contact with the sheet 4b, which prevents accidental removal of the connecting member 15a.

The small length L of the flexible hose 14 makes it possible to minimize the consumable material. In fact, after having been emptied, or when a usage expiration date has been exceeded (in particular when the food product is a yogurt composition or similar dairy product), it is necessary to change the reservoir 4 and the dispensing line 15. Furthermore, a direct descending path is obtained (without rising) when the food product is conveyed between the opening 4d of the reservoir 4 and the outlet 16.

The device 20 for extracting the food product will now be described in reference to FIGS. 1, 2A-2B and 3A-3B.

In the apparatus 1 diagrammatically illustrated in FIG. 1, the extraction device 20 is connected to the flexible hose 14 so as to circulate the food product channeled in the dispensing line 15 toward the outlet 16. The extraction device 20 comprises the pump 5, which is of the peristaltic type. Hereafter, the term peristaltic will be understood in its broadest interpretation, with the understanding that this term designates any pumping member using mechanical pressure on the outside of the flexible hose 14.

In this non-limiting example, the pump 5 is made up of a frame 5a, visible in FIG. 3A, on which a motor M, here electric, is fastened, whereof the shaft 21 rotates a cage hereafter called a rotor 22 including a plurality of rollers 23a, 23b, 23c. FIG. 1 shows that in the pump 5, the flexible hose 14 is simply bowed (a single curve extending between an upper end away from the reservoir 4 and the lower end away from the outlet 16). The pressing rollers 23a, 23b, 23c push on the interface of the bowed portion. These rollers 23a, 23b, 23c are typically mounted freely rotating at the end of radial arms 24 and come together at the shaft 21 defining the axis of rotation X. These radial arms 24 are secured to said shaft 21, which is rotatably connected to the electric motor M. This motor M here is equipped with a sensor S that counts the number of rotational revolutions of the shaft 21 and uses an electrical circuit 25 to send that information to the control unit 26.

In the flexible hose 14 engaged in the pump 5, the inner space for the food product between two of the rollers 23a, 23b, 23c may correspond to a volume of approximately 1 mL. For a rotor 22 with three rollers 23a, 23b, 23c, it will thus be understood that a little more than 3 mm can be evacuated during a complete revolution of the rotor 22. Of course, a rotor 22 comprising another number of rollers (for example greater than or equal to four) may be used.

The flexible hose 14 may be made from a shape memory material such as silicones or a flexible material having similar properties (in particular elastic deformation, crushing resistance), that material being suitable for being in contact with food. In reference to FIG. 4A, the flexible hose 14 for example has an outer diameter D2 at least equal to 10 mm and preferably about 12 mm, knowing that the inner diameter D1 of that hose 14 is preferably greater than 5-6 mm, and for example approximately 7 mm. It will be understood that the thickness of the wall of the hose 14 may be chosen between 2 and 3 mm, for example 2.5 mm.

With this type of hose 14 and this type of food product (for example, a mixed fermented milk composition with a viscosity of about 1,100 mPa·s), the pump 5 can operate with a speed of rotation of 300 rpm (i.e., 5 rps). One may thus conclude, if 1 mL is contained in the space between two of the rollers 23a, 23b, 23c, a little more than 15 mL of food product may be recovered each second during extraction. A dose of about 90-100 mL of food product may therefore be recovered in only 6 seconds.

Referring to FIGS. 1 and 2A-2B, the pump 5 includes a stator portion 5b arranged on the periphery of the rotor 22. The stator portion 5b is part of the casing 5c, which further includes a complementary fastening portion 5d that is connected to the frame 5a and surrounds the rotor 22. The stator portion 5a forms at least one reaction surface 28 engaged with the flexible hose 14 of the dispensing line 15 in a pumping configuration in which the flexible hose 14 is locally crushed between at least one of the rollers 23a, 23b, 23c of the rotor 22 and the reaction surface 28. During the operation of the pump 5, it will be understood that the rollers 23a, 23b, 23c are in contact with the flexible line 14, which they deform and crush until sealing occurs. The angular movement of the sealing point causes, behind the crushed area, an underpressure in the hose 14, which immediately fills with fluid food product. The quantity of food product captured in the hose 14 between two of the rollers 23a, 23b, 23c is then pulsed toward a discharge side of the pump 5. In the casing 5c of the pump 5, a cylindrical inner face, called a step, is provided, against which the flexible hose is crushed by the rollers 23a, 23b, 23c to guarantee sealing of the hose. The reaction surface 28 is part of that step. An opening angle of at least 120° is provided here for the reaction surface 28 such that at any time, at least one of the three rollers 23a, 23b, 23c is across from that reaction surface 28, the hose being crushed at least at one point.

As appears in FIG. 2B, the pump 5 comprises an insertion channel 29 that passes through the casing 5c to receive the flexible hose 14. The stator portion 5b is movable, for example by sliding, between an access position to the insertion channel 29 in which the stator portion 5b is separated from the axis of rotation X, and a closed position of the insertion channel 29 in which the stator portion 5b is close to the axis of rotation X.

The casing 5c of the pump 5 may have a fastening connector on the shaft 21 of the motor M that enables easy removal of the removable part of the casing-rotor 5c, 22 of the pump 5 through the opening 7c of the enclosure 7. To that end, the motor M may have a shaft 21 extending in a direction that passes through the opening 7c. The fastening connector (not shown) is part of the fastening portion 5d and may be arranged across from the access face to the insertion channel 29, i.e., on the rear face of the casing 5c. In the state mounted on the frame 5a of the pump 5, at least the casing-rotor assembly 5c, 22 (i.e., the pump head) extends entirely inside the enclosure 7.

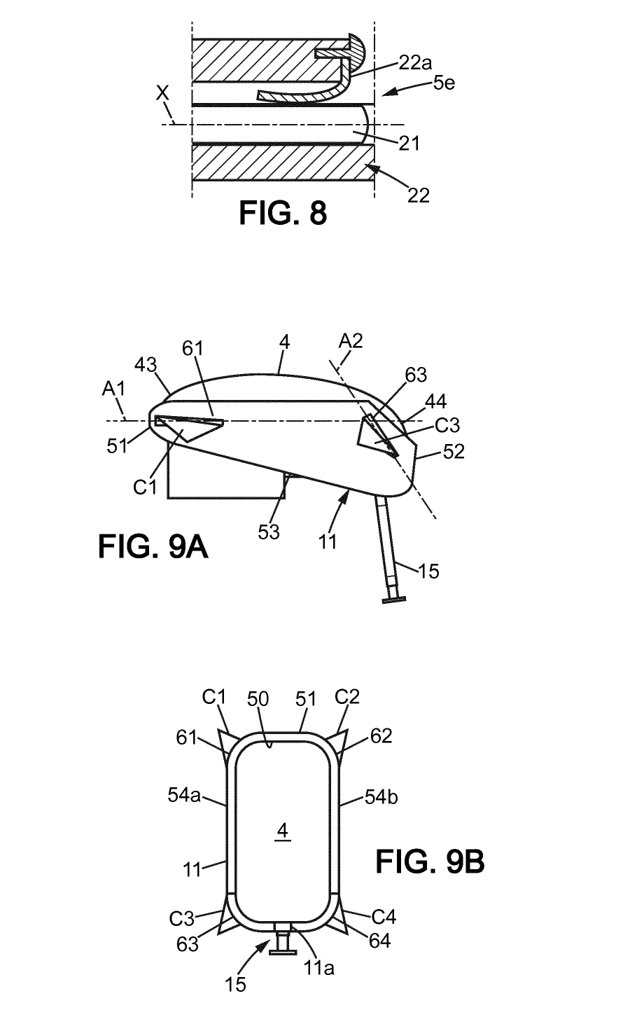

FIG. 8 shows one example of a quick connector for mounting on the shaft 21. The casing-rotor assembly 5c, 22 here is optionally removably mounted on the shaft 21 driving the pump 5 using elastic return means 22a and/or snapping members arranged inside a central orifice 5e (passing through the complementary fastening portion 5d and the rotor 22). Non-limitingly, elastic return means 22a may be provided oriented in a general direction parallel to the shaft 21. More specifically, these means may consist of a leaf spring that is positioned in the orifice 5e of the pump head in which the shaft 21 is inserted. It will be understood that the leaf spring exerts uniform pressure parallel to the longitudinal axis of the shaft 21. The shape of the leaf spring and its orientation parallel to the shaft 21 facilitate sliding (guide function) along the shaft 21 during removal of the casing-rotor assembly 5c, 22. Independently of or in combination with the preceding, the shaft 21 may for example have a flat or another mistake-proofing member to enable correct positioning of the insertion channel 29 (to ensure that the first direction of rotation cannot be confused with the second direction due to poor positioning).

More generally, it will be understood that the connection can assume any form (for example with shape matching between the shaft 21 and an engagement portion of the rotor 22) making it possible to remove, if applicable to clean, and to easily reposition the casing-rotor assembly 5c, 22 on the shaft 21 multiple times, without affecting the precision of the flow rate of food product of the peristaltic pump 5. The casing 5c extends near the opening 7c, recognizing that this arrangement at the front of the subsection S2 of the chassis 2 makes it possible to free space to position at least part of the cooling device 10 on the side of the rear wall 2a of the chassis 2.

As illustrated in FIGS. 3A and 3B, a passage 30 formed in the lower wall 7d of the enclosure 7 emerges in the collection compartment CC. This passage 30 may thus be passed through by one end of the flexible hose 14 protrudes downward with respect to the lower wall 7d. One can see in FIG. 3A that the assembly W (consumable of FIG. 4B) composed of the reservoir 4, the dispensing line 15 and the optional associated stopper 15b may be installed in the apparatus 1 basically loading the reservoir 4 in the holder 11. In one preferred embodiment, the holder 11 forms a removable tray or basket, such that the loading in the holder 11 may be done outside the storage compartment 3. In this case, the placement is facilitated, as it suffices for the operator to insert the loaded holder 11 into the storage compartment 3. The width L1 of the holder 11 is slightly smaller than the width of the storage compartment 3 (for example, with lateral play of less than 2 cm), which makes it possible, during the insertion of the loaded holder 11 to position the slit 11a substantially overhanging the passage 30. The slit 11a, in which the dispensing line 15 is inserted, then makes it possible to guide the positioning of the reservoir 4 in the holder 11 before that insertion on the one hand, and to preserve a globally vertical arrangement of the dispensing line 15 after that insertion (and before placement of the removable part 5c, 22 of the pump 5) on the other hand.

The removable part 5c, 22 (without the motor M and without the frame 5a) of the pump 5 is mounted in the subpart 7b of the enclosure 7 and is configured in the access position to the insertion channel 29 as illustrated in FIG. 2B. The flexible hose 14 of the dispensing line 15 in its configuration illustrated in FIG. 3A is placed in the insertion channel 29. Before moving the stator portion 5b into the closed position, the operator ensures that the connecting member 15a of the dispensing line 15 extends completely outside the casing 15 (while avoiding any pinching). After closing, the outlet 16 is flush with or protrudes a short distance with respect to the outlet of the passage 30 into the collection compartment CC. The optional stopper 15b may be removed and thrown away only when this raised position of the outlet 16 is obtained (i.e., after fastening of the flexible hose 14 inside the casing 5c).

It will be understood that the operation for loading the reservoir 4 associated with the dispensing line 15 may be done quickly, which is advantageous to respect the cold chain. Of course, the door 8 may be closed during the operation for connecting the dispensing line 15 and the operation for loading the reservoir 4 in the holder 11.

In reference to FIG. 7, it is possible to see the steps making it possible to remove the consumable assembly W formed by the reservoir 4 and the dispensing line 15, in particular with separation for reuse of the holder 11 in step 31 and the removable part 5c, 22 of the pump 5 in step 32. It will be understood that only the rotational driving element (21, M) forms a stationary part of the arrangement allowing circulation of the food product. In this circulation arrangement, the detachable part of the pump 5 and the consumable assembly W are easily separated (as shown in FIG. 7) away from the chassis 2 of the apparatus 1.

In reference to FIG. 1, the rotational driving element (21, M), which in particular comprises the electric motor M, is configured here to rotate the rotor 22 of the pump 5 around the axis of rotation X in a first direction corresponding to a descending circulation of the food product toward the outlet 16 (direction of the arrow 41) and in a second direction (direction of the arrow 42) corresponding to an ascending circulation of the food product. The first direction as illustrated in FIG. 1 is reversed in the following FIGS. 2A to 3B, with the understanding that the pump 5 may indifferently have an insertion channel 29 placed on either side. To perform the distribution function of the apparatus 1, the rotational driving element (21, M) operates at a predetermined speed for each of the directions, that speed being able to be the same in the first direction and the second direction.

The extraction device 20 illustrated in FIG. 1 also includes means for controlling the dispensing of the food product. The electrical power supply of the extraction device 20, of the autonomous type or connected to a current distribution grid, is of a type known in itself and will not be outlined here. The control unit 26 has at least one management module 26a for the pump 5 suitable for receiving user commands coming from a user interface 33 connected to the control unit 26. A primary button 33a and a plurality of other buttons or keys 34a, 34b, 36 may be provided in said user interface 33, which furthermore comprises a display screen 35. At least one of the keys may be provided to display a programming menu that for example makes it possible to parameterize the viscosity of the food product. With a predetermined speed of rotation of the rotor 22, this viscosity entered by the user may be taken into account by the control unit 26 to adjust the number of revolutions to be performed during a command for a dose, that number being able to be increased for a high viscosity and reduced for a low viscosity.

The management module 26a has a routine for determining a usage duration of the assembly formed by the reservoir 4 and the dispensing line 15, for example obtained by taking into account an event representing a beginning of use (for example, actuating an initialization procedure at the user interface 33 that is necessary upon the very first use of the new reservoir 4 and/or information that a threshold has been reached in the storage compartment 3 and/or a signal triggered by a detector upon insertion of the holder 11 into the compartment 3). As a non-limiting example, pressing two keys 34, 35 of the user interface 33 may serve to initiate the initialization procedure of the new reservoir 4.

The management module 26 may also in particular receive one or more of the following pieces of information:
information representative of temperature measurements in the enclosure 7, in particular in the storage compartment 3 of the subpart 7b where the pump 5 is housed;
information representative of measurements of a filling state of the reservoir 4;
information representative of a number of rotational revolutions of the shaft 21 of the motor M, counted by the sensor S.

This information may be displayed on the display screen 35, as well as information representative of having exceeded a threshold relative to the usage duration of the reservoir 4 and dispensing line 15 assembly. The control unit 26 and the interface 33 may have components of a type known in itself that will not be outlined here.

The management of the motor M during commissioning of the apparatus 1 will now be described in reference to FIGS. 1 and 3B.

The electric motor M with two directions of rotation may initially be actuated in the first direction corresponding to the arrow 41, for example when the user presses on two keys 34, 35 simultaneously, typically in response to an invitation shown on the display screen 35. Optionally, during this initialization, the motor M rotates the rotor 22 by a predetermined number of revolutions in the first direction (direction of the arrow 41) so that the food product flows in the flexible hose 14 of the dispensing line 15. In one preferred embodiment, this actuating accounts for the fact that the flexible hose 16 extends both in the enclosure 7, which is refrigerated, and in the passage 30 with, furthermore, an end portion that can protrude in the collection compartment CC as far as the outlet 16. More specifically, the pump 5 is commanded by the control unit 26 so as always to store the food product above the passage 30, i.e., completely in the inner volume of the enclosure 7. To that end, the management module 26a generates a rotation command corresponding to a necessary number of revolutions and sufficient to obtain that limited movement of the food product.

In order to store the food product present in the flexible hose 14 completely above the passage 30, it is provided, in response to a command to extract the food product that may be initiated by the primary button 33a or by a specialized key 36:
to remove the food product from the reservoir 4 by rotating the rotor 22 of the pump 5 in the first direction, such that a dose corresponding to the command may be recovered below the outlet 16; and
when said dose has been removed from the dispensing line 15 (i.e., when the number of revolutions necessary to extract the doses been reached), to move the food product remaining in the flexible hose 14 away from the outlet 16, by rotating the rotor in the second direction (direction of the arrow 42).

Preferably, the rotation of the rotor 22 in the second direction is commanded selectively by the management module 26a so that the rotational movement is always the same, for example one or two revolutions or even less than one revolution. The driving of the pump 5 in the opposite direction according to the arrow 42 thus makes it possible to raise the food product away from the outlet 16, such that the food product present in the dispensing line 15 is stored in or at least near the refrigerated storage compartment 3 (in the subpart 7b of the enclosure 7). In order to avoid any air rising up inside the reservoir 4, the control unit 26 can issue a predetermined food command such that the rotation in the second direction does not exceed one or two complete revolution(s) of the rotor 22. It is advantageous to provide a length L of the flexible hose 14 adjusted to the configuration of the apparatus 1 so as not to protrude too much in the collection compartment CC, for example with a distance smaller than 2 cm. Thus, the time necessary to raise the food product is very short and can be much shorter than one second. During this short time interval, the control unit 26 selectively commands the power supply of the electric motor M, driving the rotation of the rotor 22 in the second direction (direction of the arrow 42), then commands the stop of the electricity supply to that motor M. This direction reversal is transparent to the eyes of the user who ordered the dose.

In one embodiment, when the user activates the extraction using the pushbutton 33a, the control unit 26 sends a command to rotate the rotor 22 of the pump 5 by a predetermined number of revolutions in the first direction, for example 30 revolutions, so as to deliver a predefined dose of food product (for example, about 90 or 100 mL).

Alternatively, the command may be done in a customized mode in which the filling duration of the cup 6 is determined directly by the user. In that case, the duration of pressing on a specialized key 36 may be taken into account and/or the release of the pushbutton 33a (or similar actuator) is interpreted by the control unit 26 as an end-of-extraction request. A contactor associated with the specialized key 36 or the pushbutton 33a may make it possible to initiate the power supply of the electric motor M in a manner known in itself. During the on-demand filling, the sensor S counts the number of revolutions performed by the rotor 22, and that number is stored in a memory at the disposal of the control unit 26. A calculation routine of the management module 26a makes it possible to convert the number of revolutions into a quantity of food product that is typically expressed in milliliters (or optionally in grams) and the display screen 35 then makes it possible to display the quantity resulting from that conversion.

Preferably, the filling duration may not exceed a predetermined threshold corresponding to a maximum authorized quantity, which is for example a function of the capacity of the cup 6 or other container provided to collect the food product. It will be understood that, irrespective of the quantity of extracted food product, the same type of cycle is performed with a rotation phase of several revolutions of the rotor 22 in the first direction immediately followed by a predetermined rotation phase not greater than one or two revolutions in the second direction.

In one embodiment, the extracted food product flow rate, analyzed in the number of revolutions of the rotor 22 (in particular using the sensor S), may be counted decreased by a predetermined number of revolutions that corresponds to what is necessary for the entire content of the reservoir 4 to flow. Typically, the content of the reservoir 4 before use is constant and about 1-7 kg, for example 5 kg. A remaining value representative of the quantity of product still available may be read on the display screen 35 and/or an indicator signaling a need to renew the food product may be displayed when the control unit 26 determines that the quantity of product still available is below a predetermined threshold.

The control unit 26 may also be configured to block a food product extraction command entered using the user interface 33 in response to detection of the noncompliant state of the apparatus 1. Such a noncompliant state may be detected when the temperature in the storage compartment 3 and/or in the subpart 7b of the enclosure 7 is outside an operating range, or when the usage duration of the product from opening of the reservoir 4 has been exceeded.

Optionally, it may be provided to detect a closing state of the door 8. The control unit 26 for example receives a signal corresponding to closing of the door 8 sent by a door sensor 37, 37a. The detection of the opening of the door 8 may be magnetic, the door sensor 37, 37a in that case having a magnetic member 37a secured to the door 8 and a detector device 37 secured to the rest of the chassis 2, as shown in FIG. 3A. When the control unit 26 receives the signal representative of the closing of the door, it authorizes the dispensing and a corresponding display mode may be activated at the display screen 35. It will be understood that such a door sensor 37, 37a facilitates verification by an operator that the enclosure 7 is indeed isolated.

Additionally or alternatively to the door sensor 37, 37a, a pump sensor 38, 38a may be provided to detect an operational configuration of the pump 5. As illustrated in FIGS. 2A-2B, the removable pump head formed by the casing-rotor assembly 5c, 22 for example has a magnetic member 38a, here onboard in the casing 5c, which can be detected by a probe 38 mounted in the door 8. When the pump is engaged on the drive shaft 21, in the manner illustrated in FIG. 8 or more generally by cooperation between matching shapes (typically male/female) between the shaft 21 and the corresponding engagement part of the rotor 22, maintenance in the blocked position may be obtained using the door 8. In this preferred but non-limiting embodiment, the door 8 has a surface 8b (visible in FIG. 3A) for engagement contact against the outer face 39 of the pump 5. The surface 8b may be defined over a local inner projection of the door 8. The bearing of the surface 8b toward the inside, with pressure on the surface 39 when the door 8 is in its closed state, makes it possible to lock the fastening configuration of the rotor 22. In other words, a relative movement of the rotor 22 (typically by sliding) with respect to the drive shaft 21 of the motor M is no longer possible after that locking. Thus, the pump 5 is correctly positioned.

Optionally, the control unit 26 can receive, from the probe 38, a signal corresponding to a detection of the magnetic member 38a. If the magnetic member 38a is detected, the control unit 26 interprets the signal as closure of the door 8 and/or as a ready-to-operate state of the pump 5. If the magnetic member 38a is not detected, the control unit 26 interprets that as a disconnection of the pump 5. In the ready-to-operate state, the control unit 26 selectively puts the extraction device 20 in an operational state for which dispensing of the food product is accessible. A corresponding display mode may be activated at the display screen 35. In the opposite case, the control unit 26 blocks all or some of the command functions or activates an alert signaling that the placement of the pump 5 is not complete.

It will be understood that the sensors 37-37a and/or 38-38a may be of the nonmagnetic type, for example with detection of mechanical engagement in the closed state of the door 8. Furthermore, the probe 38 of the pump sensor 38, 38a may also be placed in a part of the apparatus 1 separate from the door 8, for example in a maintaining or fastening arm of the pump 5.

Embodiments of the mounting of the reservoir 4 in the holder 11 will now be described in reference to FIGS. 3A-3B, 4B, 7 and 9A-9B.

As illustrated in FIG. 9A, the holder 11 for example has a rear end 51, a front end S2 and a bottom wall 53 whereof the length may be identical to the length 40 of the reservoir 4. The rear 51 and front 52 ends are each formed by a wall element that extends upward from the bottom wall 53. The holder also includes left and right panels 54a, 54b, respectively, which extend between the rear end 51 and the front end 52. The width L1 of the holder 11 makes it possible to receive the reservoir 4 between the panels 54a and 54b, in an adjusted manner or with slight play when the reservoir 4 is not empty. However, protruding side portions for example from the corners C1, C2, C3, C4 of the reservoir 4 define a surplus with the reservoir 4. The upper face of the holder 11 defines an upper opening 50 that extends between the front end 51 and the rear end 52.

One can see that the bottom wall 53 is inclined descending downward and toward the front end 52, so as to facilitate the flow of the food product with a single outlet 4d. The incline may be continuous or discontinuous and the incline angle of the bottom wall 53 with respect to the horizontal does not exceed 40 or 45° (angle for example comprised between 10 and 30°). As an example, the rear end 51 is raised with respect to the front end 52. The wall element at the front end 52 preferably defines the vertical slit 11a and/or the slit 11a extends as far as the bottom wall 53 near the front end 52, at a level (lower point of the holder 11) situated completely below the rear end 43 of the reservoir 4 in the loaded configuration. FIG. 9A shows this loaded configuration. The incline may be zero on the side of the rear end 51, so as to reduce the bulk heightwise.

The holder 11 is thus generally in the shape of a basket with a support slope of the reservoir 4 and is easily inserted and removed in the storage compartment 3 when the door 8 is in the open position. In the non-limiting example of FIGS. 9A and 9B, the reservoir 4 is in the form of a flexible pouch with rear corners C1, C2 and front corners C3, C4 each protruding outward. These corners C1, C2, C3, C4 can for example be part of the peripheral weld seam 4c visible in FIG. 4B. It will be understood that the corners C1, C2, C3, C4 are each spaced apart in pairs and for example separated by a rectilinear portion 4e (visible in FIG. 4B) of the weld seam 4c. The panels 54a, 54b are respectively split near the rear end 51 and near the front end 52, so as to form removable fastening members for the reservoir 4. More specifically, the removable fastening members are distributed between rear fastening members comprising rear slits 61, 62 and front fastening members comprising front slits 63, 64. These slits 61, 62, 63, 64 make it possible to insert the front and rear corners C1, C2, C3, C4 through the panels 54a, 54b. The corners C1, C2, C3, C4 are then respectively engaged in the slits 61, 62, 63, 64 and ensure maintenance of the reservoir 4 in a lying down position in which the opening 4d faces the slit 11a (the opening 4d then being situated at equal distances from the two panels 54a, 54b). It will be understood that the rear end 43 of the reservoir 4 is blocked in a stationary and adjacent position with respect to the rear end 51 of the holder 11 owing to the rear corners C1, C2 that protrude through the rear slits 61, 62, while the front end 44 of the reservoir 4 is blocked in a stationary and adjacent position with respect to the front end 52 of the holder 11 owing to the front corners C3, C4 that protrude through the front slits 63, 64.

In reference to FIG. 9A, the rear corners C1, C2 and front corners C3, C4 are blocked in the slits 61, 62 and 63, 64, which can be narrower at one of their ends. This type of format makes it possible to insert the corners C1, C2, C3, C4 on the side of the wider end of the slits 61, 62, 63, 64 and to then block each of the corners C1, C2, C3, C4 at the narrowest end. In one preferred option with an inclined position of the reservoir 4 at least near the front end 44, this narrow end may be situated at the front, such that the effect of gravity naturally pushes the corners C1, C2, C3, C4 on the side of the narrowest end (by downward sliding). The gripping thus obtained at the corners C1, C2, C3, C4 makes it possible to keep the reservoir 4 in a stretched position that limits the formation of creases (little or no possibility of creasing during suction by the pump 5) and product retention, such that losses at the end of use of the reservoir 4 are significantly reduced.

FIG. 9A shows that the rear slits 61, 62 can be elongated in a first direction A1 that here is horizontal, while the front slits 63, 64 can be elongated in a second direction A2 different from the first direction A1. The front slits 63, 64 extend lower than the rear slits 61, 62 in the loaded configuration of the holder 11. It will be understood that the elongated shapes of the slits 61, 62, 63, 64 with a small play for the insertion of the corners C1, C2, C3, C4 make it possible to configure the reservoir 4 in a practically horizontal position, in this example with a gradual incline on the side of the front end 44.

In this example, the reservoir 4 has a parallelepiped format with four corners coming together at the rear C1, C2 and front C3, C4 corners. When the sheets 4a, 4b or similar walls of the reservoir 4 have an oblong format, the inner edge of the seam 4c or similar peripheral weld area may be rounded or curved toward the small sides, the outer edge of the seam 4c remaining rectangular such that each of the corners C1, C2, C3, C4 formed by that seam 4c has a generally triangular shape, as clearly shown in FIGS. 9A-9B. The corners C1, C2, C3, C4 here are engaged with the edge of the corresponding slits 61, 62, 63, 64. In one alternative embodiment, the holder 11 may have fastening members by gripping as a complement to or replacement for all or some of said slits 61, 62, 63, 64. Also alternatively, the peripheral weld seam 4c or any other marginal portion of the reservoir 4 may be engaged with removable fastening members at the rectilinear portions remote from the corners C1, C2, C3, C4. It is also allowable to provide a different arrangement of the fastening members or a number of fastening members smaller than four, for example by eliminating one of the rear slits 61, 62 and/or one of the front slits 63, 64 (with the understanding that it is also possible to provide a continuous slit over at least one of the panels 54a, 54b for the insertion of two corners C1 and C3 or C2 and C4 or other protruding projections of the reservoir 4).

The oblong or similarly elongated format of the rear slits 61 and 62, in a horizontal direction (when the holder 11 is engaged in the storage compartment 3), makes it possible to guide the reservoir 4 horizontally on the side of the rear end 43. The oblong or similarly elongated format of the front slits 63, 64, in an inclined direction substantially parallel to the slope defined by the bottom wall 53, makes it possible to downwardly incline part of the reservoir 4 close to the front end 44. Thus, even when little food product remains in the reservoir 4, for example less than 10% or 20% of the initial quantity, the general (practically horizontal) position of the reservoir 4 in the direction of the height remains the same, with the same length L and the same width, and above all with the same height level difference between the rear end 43 (raised using the rear slits 61, 62) and the front end 44 (still the same level using the front slits 63, 64). FIG. 7 illustrates the fact that the reservoir 4, at the end of use, may have a deformed appearance with the sheet 4a or similar wall having an outer face that has become concave, such that the final height of the reservoir 4 is reduced relative to its initial height H4.

However, due to the maintenance by the removable fastening members, the width and the length L may be unchanged or very slightly modified. It must also be noted that the slits 63, 64 are positioned at the same high level as the opening 4d of the reservoir 4, such that said opening 4d may be kept at its height level independently of the variations in the inner volume of the reservoir 4 during food product extraction operations.

One of the advantages of an apparatus 1 lies in the effective control of the preservation and dispensing of a food product such as yogurt, for which many requirements exist and which is typically difficult to make flow due to its viscosity. Furthermore, the apparatus 1 may have a compact and practical arrangement for replacement operations for the consumable assembly W, due to the spatial distribution of that assembly (just behind the door 8). As an example, the ratio between the volume of food product contained in the reservoir 4 before the distribution and the upper volume defined by the chassis 2 above the passage 30 may be comprised between 1:10 and 1:5. With a collection compartment CC with a height smaller than or equal to about 20 cm (for example about 15 cm), the outer volume of the apparatus 1 may represent at most 12 times the volume of the food product. The height H of the apparatus 1 may be smaller than 60 cm (for example about 55 cm) and the storage compartment 3 suitable for receiving a reservoir 4 containing 5 kg of food product. The apparatus 1 is therefore particularly easy to install in all locations and is user-friendly, while also respecting the strict requirements for hygienic preservation.

It will be understood that each of the examples and each of the embodiment details previously described may be used alone (for example, the operation of the pump 5 of the extraction device 20 on the one hand and the cooperation between the reservoir 4 and the holder 11 on the other hand) or in combination. It must thus be obvious for those skilled in the art that the present invention allows embodiments in many other specific forms without going beyond the scope of application of the invention as claimed.

1. An apparatus for preserving and dispensing, on demand, a liquid or pasty food product, comprising:
a storage compartment;
a food product reservoir, which is in the form of a flexible pouch;
a dispensing line connected to the reservoir and having an outlet, the dispensing line channeling the food product and comprising a flexible hose;
an extraction device for extracting the food product channeled into the dispensing line, configured to circulate the food product toward the outlet in response to a command to dispense a dose of food product;
a cooling device for refrigerating the food product contained in the reservoir when the reservoir is in the storage compartment;
wherein said extraction device comprises a peristaltic pump from which one end of the dispensing line extends including the outlet, the dispensing line being connected to the reservoir at another end that is opposite the outlet, the pump having a rotor rotating around an axis of rotation at least in a first direction corresponding to a descending circulation of the food product toward the outlet, the extraction device being configured to selectively modify circulation of the food product in the dispensing line at the end of dispensing of a dose of food product, by rotating the rotor in a second direction corresponding to an ascending circulation of the food product, the rotation in said second direction being controlled so that the product can rise in the dispensing line without reaching an upper level downstream of the reservoir, in order to avoid any air rising up inside the reservoir.

2. The apparatus according to claim 1, wherein the pump comprises:
the rotor, which comprises a plurality of rollers; and
a rotational driving element configured to rotate the rotor in said first direction and in said second direction, owing to which it is possible to at least partially empty the food product from said end including the outlet, at the end of dispensing a dose of food product.

3. The apparatus according to claim 2, comprising a control unit for controlling the rotational driving element according to cycles each comprising a phase for rotating the rotor by several revolutions in the first direction and a predetermined rotation phase not greater than one or two revolutions in the second direction.

4. The apparatus according to claim 3, wherein the extraction device comprises the control unit and a user interface connected to the control unit, the user interface comprising a display screen suitable for indicating at least one piece of information from among the following information:
information representative of a filling state of the reservoir;
information representative of a refrigeration state in the storage compartment;
information representative of a usage duration of a reservoir and dispensing line assembly;
information representative of having exceeded a usage duration threshold of the reservoir and dispensing line assembly.

5. The apparatus according to claim 1, wherein the pump further comprises:
a stator portion arranged on the periphery of the rotor and forming at least one reaction surface engaged with the flexible hose of the dispensing line in a pumping configuration in which said hose is locally crushed between at least one of the rollers and the reaction surface; and
an insertion channel to receive the flexible hose, the stator portion being movable between a position for accessing the insertion channel in which the stator portion is separated from the axis of rotation and a closed position of the insertion channel in which the stator portion is closer to the axis of rotation.

6. The apparatus according to claim 1, wherein the reservoir and the pump are arranged in a same enclosure including the storage compartment and refrigerated by the cooling device.

7. The apparatus according to claim 6, wherein the enclosure comprises a frontal access opening,
wherein the pump includes a drive shaft extending along a virtual axis that intersects the frontal access opening,
and wherein the pump has a casing containing the rotor and is situated near the frontal access opening of the enclosure in a mounted state inside the enclosure, the reservoir and the dispensing line defining a consumable assembly that is removable with respect to the casing through the frontal access opening.

8. The apparatus according to claim 1, wherein the pump includes a drive shaft on which the rotor is mounted removably, the rotor being in a operating state when secured in rotation to the drive shaft,
and wherein the apparatus is provided with a folding door to close the storage compartment and configured to engage with the pump in a closed position of the door.

9. The apparatus according to claim 1, wherein the outlet is situated in or near a collection compartment on the side of the lower end of the apparatus, the storage compartment extending on the side of an upper end of the apparatus to store the reservoir completely above the outlet.

10. The apparatus according to claim 1, wherein the dispensing line extends continuously descending between the end opposite the outlet and the end including the outlet.

11. The apparatus according to claim 1, wherein the reservoir is a flexible pouch, the shape and inner volume of which change with the help of the pump to facilitate extraction of the food product outside the reservoir.

12. An arrangement for circulating a liquid or pasty food product capable of cooperating in an apparatus according to claim 1, wherein the arrangement comprises a food product reservoir, which is in the form of a flexible pouch, a dispensing line that comprises a flexible hose and an outlet, and a peristaltic pump from which one end of the dispensing line extends including the outlet, the dispensing line being connected to the reservoir at another end opposite the outlet, said pump having:
a rotor including several rollers;
a stator portion arranged on the periphery of the rotor, and forming at least one reaction surface engaged with the flexible hose of the dispensing line in a pumping configuration, in which said hose is locally crushed between at least one of the rollers of the rotor and the reaction surface; and
a rotational driving element configured to selectively rotate the rotor around an axis of rotation in a first direction and in a second direction opposite the first direction, so that the circulation of the food product in the dispensing line is modified.

13. A method for preserving and dispensing a liquid or pasty food product contained in a flexible pouch like reservoir outside which the food product can be extracted by actuating an extraction device and set in motion by a peristaltic pump, the method comprising the following steps essentially consisting of:
cooling the reservoir in a cooling area;
engaging the pump with a flexible hose of a dispensing line connected to the reservoir;
in response to a command to extract food product, extracting the food product from the reservoir by rotating a rotor of the pump in a first direction, such that a dose corresponding to the order can be recovered at an outlet of the dispensing line; and
when said dose has been extracted from the dispensing line, moving the food product remaining in the dispensing line away from the outlet, by rotating the rotor of the pump in a second direction, whereby said remaining food product is brought closer to the cooling area; the rotation in the second direction being controlled so that the product can rise in the dispensing line without reaching an upper level downstream of the reservoir, in order to avoid any air rising up inside the reservoir.
